(19) United States
(12) Patent Application Publication
(10) Pub. No.: US 2026/0301083 A1
(43) Pub. Date: Oct. 1, 2026

(54) DISTRIBUTED PHOTOVOLTAIC OPERATION MANAGEMENT SYSTEM

(71) Applicant: HUANENG POWER INTERNATIONAL INC. ANHUI WIND POWER BRANCH, HEFEI (CN)

(72) Inventors: XIN WANG, HEFEI (CN); BO XU, HEFEI (CN); XINGYU DU, HEFEI (CN); FANG QI, HEFEI (CN); CHEN CHEN, HEFEI (CN); YIFEI REN, HEFEI (CN); LINGXI YIN, HEFEI (CN); LIANGDONG WANG, HEFEI (CN)

(73) Assignee: HUANENG POWER INTERNATIONAL INC. ANHUI WIND POWER BRANCH, HEFEI (CN)

(21) Appl. No.: 19/400,124

(22) Filed: Nov. 25, 2025

(30) Foreign Application Priority Data
Apr. 1, 2025 (CN) 202510415831.3

(51) Int. Cl. G06Q 50/06; H02J 3/38; H02J 13/12; H04L 9/06; H04Q 9/00; H02J 101/24; H02J 103/30

(52) U.S. Cl. CPC G06Q 50/06; H02J 3/38; H02J 13/12; H04L 9/0631; H04Q 9/00; H02J 2101/24; H02J 2103/30; H04Q 2209/60; H04Q 2209/886

(57) ABSTRACT

The disclosure provides a distributed photovoltaic operation management system, which belongs to the technical field of photovoltaic power generation. The system includes: a device control module, including a smart meter deployed in a photovoltaic power station, a data collector on an inverter, a video monitoring device and a smart wearable device, where the device control module is configured for collecting data and environmental information of a photovoltaic power station device, and regulating and controlling the photovoltaic power station device; a data transmission module, configured for providing an encrypted data transmission channel and supporting a breakpoint continuous transmission mechanism; and a data processing module, configured for receiving data transmitted by the data transmission module and processing received data; where the data collected by the device control module is encrypted and transmitted to the data processing module by the data transmission module.

### CROSS-REFERENCE TO RELATED APPLICATIONS

This application claims priority of Chinese Patent Application No. 202510415831.3, filed on Apr. 1, 2025, the content of which is hereby incorporated by reference.

### TECHNICAL FIELD

The disclosure relates to the technical field of photovoltaic power generation, and in particular to a distributed photovoltaic operation management system.

### BACKGROUND

With the development of society and the progress of science and technology, renewable energy plays an increasingly prominent role in the energy structure. As a clean and efficient energy source, photovoltaic power generation is gradually becoming an important force in global energy transformation. Under the background of "double carbon", industrial and commercial photovoltaic has a strong development momentum, and its advantages and profit-making mechanism have also attracted much attention.

At present, most distributed industrial and commercial photovoltaic projects adopt the operation mode of "spontaneous self-use, and the surplus electricity is connected to the Internet", and the self-use electricity bill needs to be settled between the investor and the user. At present, the information management of industrial and commercial photovoltaic projects is still mainly based on the inverter manufacturer's cloud platform, which may only realize the working state and data collection and monitoring of the inverter device itself, and it is difficult to support the daily business operation of the power station investors (or operators) after taking over the power station. At present, the project unit uses manual on-site meter reading to complete the data copying and accounting work, which consumes a lot of manpower, material resources and financial resources, and manual calculation under the line is prone to errors, resulting in the lag of electricity bill settlement and adversely affecting the long-term cooperation between the two parties. In addition, the problem of electricity charge recovery is more difficult in the industry. Due to factors such as electricity quantity confirmation, invoice sending, and too long fund approval process, the photovoltaic construction party's funds are slow to withdraw or even may not be recovered, resulting in a funding gap and operational risks.

### SUMMARY

The disclosure provides a distributed photovoltaic operation management system, which is used to solve the problems of single function, low efficiency and the like existing in the existing photovoltaic operation management system.

In order to achieve the above objectives, on the one hand, the embodiments of the disclosure provide a distributed photovoltaic operation management system, the distributed photovoltaic operation management system includes a device control module, including a smart meter deployed in a photovoltaic power station, a data collector on an inverter, a video monitoring device and a smart wearable device, where the device control module is configured for collecting data and environmental information of a photovoltaic power station device, and regulating and controlling the photovoltaic power station device; a data transmission module, configured for providing an encrypted data transmission channel and supporting a breakpoint continuous transmission mechanism; and a data processing module, configured for receiving data transmitted by the data transmission module and processing received data; where the data collected by the device control module is encrypted and transmitted to the data processing module by the data transmission module.

The distributed photovoltaic operation management system provided by the disclosure integrates smart meters, inverters and other devices to realize multi-source data collection and edge preprocessing, and ensures transmission safety through AES encryption and breakpoint continuous transmission. The data processing module integrates three-dimensional dynamic modeling and generative adversarial network (GAN) to accurately predict device faults and self-optimize, and combines with blockchain to realize transparent settlement of electricity bills. The control terminal provides visual interaction and closed-loop instruction verification, forming a distributed photovoltaic full-link management system integrating data intelligent analysis, risk early warning and efficient operation and maintenance, which significantly reduces the operation and maintenance cost and improves the anti-risk ability of the power station. At the same time, a variety of services such as power collection, power settlement, invoice issuance and user service are provided.

### BRIEF DESCRIPTION OF THE DRAWINGS

In order to explain the technical scheme of the disclosure or the prior art more clearly, the drawings needed to be used in the description of the embodiments or the prior art will be briefly introduced below. Obviously, the drawings in the following description are some embodiments of the disclosure, and other drawings may be obtained according to these drawings without creative efforts for ordinary skilled in the field. In the attached drawings:

FIG. 1 is a schematic structural diagram of a distributed photovoltaic operation management system according to embodiments of the disclosure;

FIG. 2 is a schematic structural diagram of a data processing module according to embodiments of the disclosure;

FIG. 3 is a flow chart of the encryption and breakpoint continuous transmission mechanism of the data transmission module according to embodiments of the disclosure;

FIG. 4 is a flowchart for constructing an intelligent mapping model according to embodiments of the disclosure;

FIG. 5 is a flowchart of fault prediction and self-optimization according to embodiments of the disclosure; and

FIG. 6 is a functional diagram of the distributed photovoltaic operation management system according to embodiments of the disclosure.

### DETAILED DESCRIPTION OF THE EMBODIMENTS

In the following, the specific implementation of the embodiments of the disclosure will be described in detail with reference to the attached drawings. It should be understood that the specific embodiments described here are only used to illustrate and explain the embodiments of the disclosure, and are not used to limit the embodiments of the disclosure.

It should be noted that the acquisition, transmission, storage, use and processing of data in the technical scheme of this disclosure comply with the relevant provisions of national laws and regulations. In the embodiment of this disclosure, some existing solutions of software, assemblies, models and other industries may be mentioned, which should be considered as exemplary, and the purpose is only to illustrate the feasibility in the implementation of the technical solution of this disclosure, but it may not mean that the applicant has already or necessarily used this solution.

Under the background of actively promoting the transformation of clean energy in the world, distributed photovoltaic power generation has become an important development direction in the energy field because of the advantages of being close to the load center, reducing transmission loss and flexible installation. In recent years, the construction scale of distributed photovoltaic power stations has exploded, and the distributed photovoltaic power stations are widely distributed in industrial workshops, commercial buildings, residential buildings and other places, making significant contributions to the optimization and sustainable development of energy supply structure. However, with the continuous expansion of the scale and the increasing number of photovoltaic power stations, the disadvantages of the traditional management model are gradually highlighted, which is difficult to meet the needs of modern power station operation and management.

The disclosure aims to solve many problems of the traditional photovoltaic operation management system, and integrates smart meters, inverters and other devices to realize multi-source data collection and edge preprocessing, and ensures transmission safety through AES encryption and breakpoint continuous transmission. The data processing module integrates three-dimensional dynamic modeling and generative adversarial network (GAN) to accurately predict device faults and self-optimize, and combines with blockchain to realize transparent settlement of electricity bills. The control terminal provides visual interaction and closed-loop instruction verification, which may realize the functions of power station asset device management, fault detection and SMS push, automatic settlement of electric quantity and electricity bill, online issuance of electronic invoices, bill notification, electricity bill recovery management, etc., and at the same time provide self-service inquiry and download services for power customers.

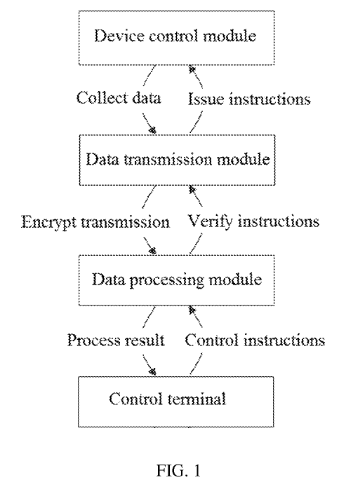

The disclosure is described in detail with reference to FIGS. 1 to 6.

As shown in FIG. 1, the embodiments of the disclosure provide a distributed photovoltaic operation management system, the distributed photovoltaic operation management system includes: a device control module, including a smart meter deployed in a photovoltaic power station, a data collector on an inverter, a video monitoring device and a smart wearable device, where the device control module is configured for collecting data and environmental information of a photovoltaic power station device, and regulating and controlling the photovoltaic power station device; a data transmission module, configured for providing an encrypted data transmission channel and supporting a breakpoint continuous transmission mechanism; and a data processing module, configured for receiving data transmitted by the data transmission module and processing received data; where the data collected by the device control module is encrypted and transmitted to the data processing module by the data transmission module.

In the distributed photovoltaic operation management system provided by the disclosure, the device control module integrates the smart ammeter, inverter, video monitoring and smart wearable device, which overcomes the limitation of traditional single acquisition, realizes comprehensive acquisition of multi-dimensional data, and provides a rich and accurate data foundation for system operation. The data transmission module uses encryption technology to ensure the security of data transmission, prevent leakage and tampering, and support breakpoint continuous transmission to avoid data loss when the network is unstable and ensure reliable transmission. The data processing module has powerful data processing ability, which breaks through the dilemma of weak function of the existing system, may deeply clean the electric energy data, accurately identify anomalies, adapt to complex electricity bill settlement rules and accurately identify potential safety hazards, greatly improve the accuracy of power station operation state judgment and reduce operating costs and risks. In fault prediction and hazard identification, the system may effectively deal with complex working conditions and environments, accurately predict device faults and identify potential safety hazards, and provide strong support for device maintenance and stable operation of power stations.

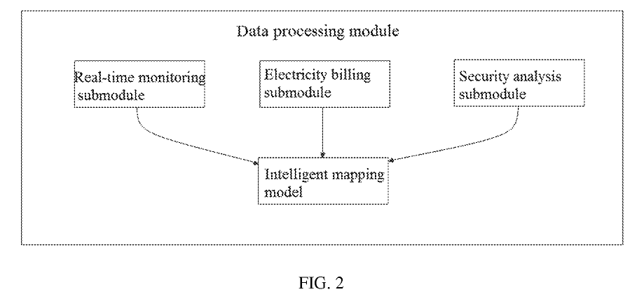

Preferably, as shown in FIG. 2, the data processing module includes: a real-time monitoring submodule, configured for cleaning and detecting abnormality of electric energy data collected by the smart meter; an electricity billing submodule, configured for generating bills and calculating photovoltaic subsidies according to the electric energy data and time-of-use electricity price rules; and a security analysis submodule, configured for identifying security risks according to environmental information collected by the video monitoring device and the smart wearable device.

Further preferably, the electricity billing submodule includes: a blockchain evidence storage unit, configured for recording hash values of electricity transaction through Hyperledger Fabric; an automatic invoicing unit, configured for docking a tax system and generating electronic invoices; and a payment collection unit, configured for integrating multiple payment interfaces and supporting automatic debit and manual payment.

In the preferred embodiment of the disclosure, the data processing module, as the core processing center of the whole distributed photovoltaic operation management system, includes real-time monitoring, electricity bill settlement and safety analysis submodules, which provide strong support for the efficient and stable operation of the system from different dimensions. The real-time monitoring submodule cleans and detects the abnormality of the electric energy data collected by the smart meter. By using the advanced data cleaning algorithm, the noise, wrong values and abnormal values in the data are quickly removed and the accuracy and reliability of the data are ensured. The electricity bill settlement submodule generates bills and calculates photovoltaic subsidies according to electric energy data and time-of-use electricity price rules, which is highly accurate and comprehensive. The module automatically and accurately calculates the user's electricity bill and generates the standard bill by using the accurate electricity bill calculation model and combining the complicated time-of-use electricity price rules. At the same time, according to the national and local photovoltaic subsidy policies and regulations, as well as the actual power generation situation of the power station, through the professional subsidy calculation model, to ensure that users enjoy the due subsidies in time and in full. Moreover, the module further integrates the blockchain evidence storage unit, the automatic invoicing unit and the electricity bill recovery unit, realizing the automation, intelligence and standardized management of the whole process of electricity bill settlement, and effectively improving the efficiency and fairness of electricity bill settlement. The safety analysis submodule identifies potential safety hazards according to the environmental information collected by video monitoring device and smart wearable device, which greatly enhances the safety of the power station. It uses cutting-edge image recognition technology and advanced environmental parameter analysis algorithm to comprehensively and deeply analyze and evaluate the overall safety situation of the power station. All kinds of potential safety hazards such as personnel intrusion, fire smoke, device overheating, abnormal vibration and so on are accurately identified in real time, and early warning information is generated in time, which provides strong technical support for the safety operation of power stations and effectively prevents the occurrence of safety accidents.

For example, in the electricity bill settlement submodule, taking a distributed photovoltaic power station as an example, a large number of distributed photovoltaic panels are connected to the power station, and the smart meter collects the power generation data of each time period in real time. Assuming that the local peak-valley time-of-use electricity price is implemented, the electricity price of the peak-hour is 1.2 yuan per kilowatt hour, and the electricity price of the valley period is 0.5 yuan per kilowatt hour. In a certain settlement period, the smart meter counts that the power generation during peak hours is 5000 kWh, and the power generation during a valley period is 8000 kWh. According to the time-of-use electricity price rules, the electricity bill settlement submodule accurately calculates that the electricity bill for this period is (5000× 1.2)+(8000× 0.5) = 6000+4000 = 10000 yuan. At the same time, according to the local photovoltaic subsidy policy, 0.2 yuan is subsidized for each kilowatt-hour. The module calculates the subsidy amount for this period as (5000+8000)×0.2=2600 yuan through the subsidy calculation model. Subsequently, the blockchain evidence storage unit records key information such as the amount, time and calculation basis of this electricity transaction in the blockchain distributed ledger, the automatic invoicing unit generates electronic invoices for the tax system, and the electricity bill recovery unit supports users to pay through various payment interfaces such as WeChat payment and Alipay payment, thus completing the whole process operation of electricity bill settlement.

Preferably, a preset intelligent mapping model is built in the data processing module, and the intelligent mapping model is configured for simulating device operation risks in extreme weather.

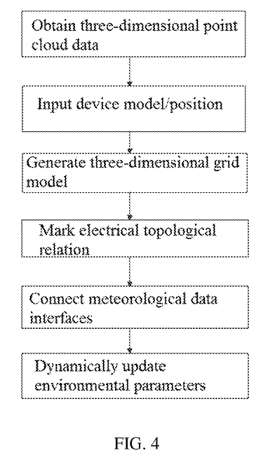

Further preferably, as shown in FIG. 4, a construction method of the intelligent mapping model includes: three-dimensional point cloud data of the photovoltaic power station is obtained; model and position of each of devices in the photovoltaic power station are inputted into the three-dimensional point cloud data to generate a three-dimensional grid model with device attributes; electrical connection topological relation is marked in the three-dimensional grid model; meteorological data interfaces are connected, future light intensity and temperature prediction are obtained.

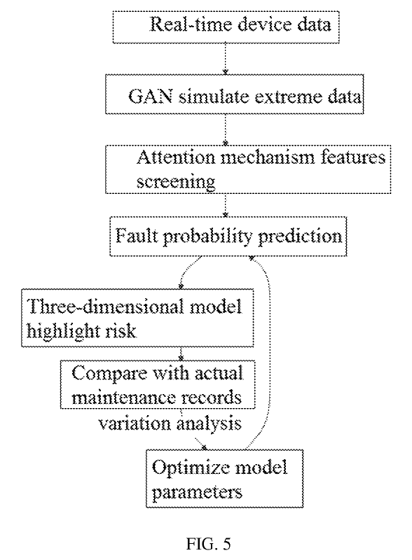

Further preferably, as shown in FIG. 5, an operation flow of the intelligent mapping model includes: data uploaded by the device control module and meteorological information in a future preset time period are obtained; device fault probability in the future preset time period is predicted through a preset fault prediction model according to obtained data and meteorological information; according to predicted fault probability, risk devices in the three-dimensional grid model are highlighted; and parameters of an algorithm in the fault prediction model are optimized according to differences between actual maintenance records and prediction results of the fault prediction model; where, the fault prediction model is constructed based on generating a countermeasure network and an attention mechanism.

In the preferred embodiment of the disclosure, the intelligent mapping model built into the data processing module provides strong support for coping with device operation risks in extreme weather. The model may accurately simulate the influence of extreme weather on device operation, and transmit the simulation results to the control terminal to assist users to make scientific decisions, effectively reduce the damage of extreme weather to the power station and ensure the stability and reliability of power generation. In the construction of intelligent mapping model, firstly, accurate three-dimensional point cloud data of photovoltaic power station are obtained, which provides basic spatial information for subsequent modeling. Then, the type and location of each device are entered in detail to generate a three-dimensional grid model with device attributes, which makes the model more suitable for the actual power station situation. Then, the electrical connection topological relation is marked to clearly present the association between devices. Finally, the meteorological data interface is connected to obtain the future illumination intensity and temperature prediction, so that the model may be simulated with meteorological factors. In the operation of the intelligent mapping model, the data uploaded by the device control module and the meteorological information in the future preset period are collected first, which provides a rich data base for forecasting. The constructed fault prediction model based on generative adversarial network and attention mechanism may fully mine the potential features and complex relationships in data and accurately predict the future device fault probability. According to the prediction results, the risk device is highlighted in the three-dimensional grid model, so that users may intuitively understand the risk distribution. At the same time, by comparing the actual maintenance records with the prediction results, the algorithm parameters of the fault prediction model are continuously optimized, so that the prediction accuracy and reliability of the model are continuously improved and better adapted to the actual operation of the power station. To sum up, the intelligent mapping model ensures the stable operation of the distributed photovoltaic operation management system with the scientific construction method and efficient operation process.

In the preferred embodiment of the disclosure, when the network interruption is restored, the data blocks associated with the high-risk device marked by the fault prediction model are preferentially transmitted to ensure that the system may quickly obtain the real-time status of key device. Combined with meteorological forecast data (such as stable future light intensity and no extreme weather), the system may skip the transmission of inverter data blocks judged as "no abnormality". For example, if the weather forecast shows that there will be no thunderstorms in the next three hours, the transmission of relevant inverter data may be suspended, saving bandwidth for high-priority tasks, reducing network congestion and improving overall transmission efficiency. Skipping the transmission of low-risk data blocks not only saves network resources, but also reduces the storage pressure of cloud or local servers.

For example, after calculation, the fault prediction model predicts that in the coming extreme weather, the fault probability of a group of photovoltaic panels located at the tuyere of the valley will reach 30% because of the possibility of large wind impact, and the fault probability of an inverter near the water accumulation area at the foot of the mountain will reach 25% due to the risk of moisture. According to these prediction results, the corresponding photovoltaic panels and inverters are highlighted in red in the three-dimensional grid model. After seeing these risky devices through the control terminal, the operation and maintenance personnel of the power station immediately organizes personnel to reinforce the photovoltaic panels at the tuyere, so as to take waterproof and moisture-proof measures for the inverters in the areas prone to water accumulation in advance.

Preferably, predicting device fault probability in the future preset time period through a preset fault prediction model according to obtained data and meteorological information includes: device operation data is simulated and generated by a generator according to historical data of the photovoltaic power station device; obtained data and meteorological information is analyzed through an attention mechanism, the features related to faults are screened out; device fault probability in the future preset time period is predicted combined with the meteorological information in the future preset time period according to device operation data simulated by the generator and the features.

In the preferred embodiment of the disclosure, in the fault prediction link, firstly, the generator in the fault prediction model simulates and generates the device operation data according to the historical data of the photovoltaic power station device. Historical data covers the power generation, temperature, light intensity of photovoltaic panels, input and output voltage, current and conversion efficiency of inverters. The generator refers to the operating features of device in different working conditions and environments in historical data, such as specific meteorological conditions (high temperature, high humidity, etc.) or operating periods (peaks and valleys), and simulates the possible operating data of device in the future preset time period. Then, the attention mechanism intervened, and the obtained device operation data and meteorological information are analyzed to screen out the features related to the fault. For photovoltaic panels, features that may cause faults, such as excessive temperature and violent fluctuation of light intensity, are given high weight and screened out. For the inverter, the key features such as unstable input and output voltage, abnormal conversion efficiency and high internal temperature are focused on. In terms of meteorological information, factors that have a significant impact on device fault, such as wind speed and direction, rainfall, humidity and other features of strong winds, are identified and screened. Finally, combining the device operation data simulated by the generator, the features screened by the attention mechanism, and the meteorological information in the future preset time period, the fault prediction model uses the internal algorithm to calculate, so as to predict the fault probability of the device in the future preset time period and provide data support for the subsequent operation and maintenance decision.

For example, based on the historical data of rainstorm, the generator simulates the operation data such as the power drop of photovoltaic panel and the possible parameter fluctuation of inverter due to moisture if there is heavy rain in the coming week. The attention mechanism analyzes the data and meteorological information, and selects the features related to the fault, such as the sealing degree of photovoltaic panel and the moisture-proof performance of inverter, which are greatly affected by heavy rain. Combined with the simulated data, the screened features and the meteorological information of rainstorm in the coming week, the model predicts that the fault probability of photovoltaic panels due to water accumulation is 5% and that of inverters due to moisture is 20%.

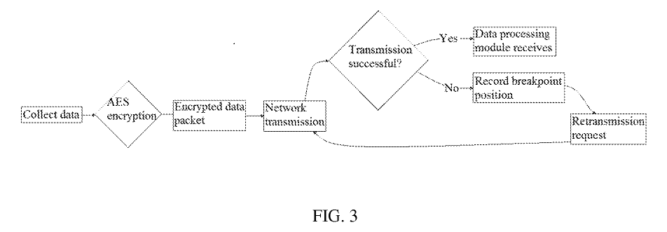

Preferably, as shown in FIG. 3, the data transmission module is configured for: performing encryption processing all kinds of data transmitted by the device control module using an AES encryption algorithm in a process of data transmission; identifying breakpoint positions of data transmission and re-initiating data transmission requests when network is abnormal according to a preset data retransmission and recovery algorithm.

In the preferred embodiment of the disclosure, when all kinds of data such as electric energy data, inverter status information and environmental information collected by the device control module are ready for transmission, the data transmission module immediately activates the AES encryption algorithm. Taking the electric energy data collected by the smart meter as an example, before transmission, the key information such as power generation, power, current and voltage in the data is scrambled and reorganized into a string of ciphertext, thus preventing the operation risk of the power station caused by data leakage. When the network is abnormal, such as signal interference and line fault, data transmission is interrupted, the data transmission module acts quickly according to the preset data retransmission and recovery algorithm. For example, if the network is interrupted when transmitting a group of inverter operation status data, the data transmission module may determine the data segments that have been successfully transmitted before the interruption and the parts that have not been transmitted. Then, the data transmission module automatically re-initiates the data transmission request, and continues to transmit the remaining data from the breakpoint to ensure that the data arrives at the data processing module in perfect condition. This mechanism effectively avoids the data loss caused by network abnormality, ensures the stability of data interaction of the whole system, provides a reliable basis for the subsequent data processing and analysis by the data processing module, and ensures that the power station operation management decision is always based on accurate and complete data.

Preferably, the distributed photovoltaic operation management system further includes a control terminal configured with a display unit, where the control terminal is configured for receiving processing results of the data processing module and providing an interactive interface. According to the user's operation, the corresponding control instruction is issued, the data collected by the device control module is displayed, and an early warning notice is generated according to the potential safety hazard identified by the safety analysis submodule.

In the preferred embodiment of the disclosure, when the user operates on the interface of the control terminal, the control terminal responds quickly and issue corresponding control instructions. For example, the operation and maintenance personnel find that the photovoltaic panel in a certain area is reduced in power generation efficiency due to dust accumulation. After selecting the device in this area in the control terminal interface, the "start cleaning device" operation button is clicked, and the control terminal immediately converts this control instruction into a specific electric signal instruction format, which is finally transmitted to the device control module through the data transmission module and the data processing module to drive the corresponding cleaning device to start working and clean the photovoltaic panel, thus improving the power generation efficiency. In terms of data display, the control terminal clearly displays the electric energy data collected by smart meters, such as real-time power generation and power curve, in the form of charts, so that users may grasp the power generation status of the power station at a glance. For the inverter state data, the conversion efficiency, fault codes and other information are presented in a detailed list, which is convenient for users to know the operation state of the device at any time. Through the environmental image data collected by video monitoring device, the control terminal displays in the form of real-time video stream to ensure that users may view the power station environment in real time. Once the safety analysis submodule identifies the potential safety hazard, the control terminal quickly generates an early warning notice. It is assumed that the security analysis submodule determines that there is a risk of electric shock in an area where someone intrudes and is close to high-voltage device through video monitoring image analysis and smart wearable device data. The control terminal immediately sends an early warning notice to the power station management personnel and related operation and maintenance personnel in various ways, such as pop-ups, short messages, etc. The notice details the location, types and possible harm of hidden dangers, reminding relevant personnel to take timely measures to eliminate potential safety hazards and ensure the safe operation of the power station.

Preferably, the device control module further includes a data processing unit for preprocessing the data collected by the device control module by using edge computing technology.

In the preferred embodiment of the disclosure, the data processing unit uses the edge computing technology, taking the electric energy data collected by the smart meter as an example, and the data processing unit uses the data filtering algorithm in the edge computing technology to preliminarily screen the collected electric energy data to remove the noise data and abnormal values. For example, when the current value collected by the smart meter has obvious jump at a certain moment, and the difference between the current value and the data before and after is too large, the data processing unit determines the data as an abnormal value and reject it to ensure that the data transmitted to the data processing module is accurate and reliable. The data processing unit uses edge computing technology to preprocess the data collected by the device control module, which not only reduces the pressure of network transmission and improves the efficiency of data transmission, but also provides valuable data for the data processing module quickly and accurately, which provides strong support for the stable operation and efficient decision-making of the whole distributed photovoltaic operation management system.

Preferably, the breakpoint continuous transmission mechanism is configured for: preferentially retransmitting data blocks associated with a high-risk device marked by the fault prediction model when a transmission is interrupted, skipping inverter data block transmission of having been predicted to be normal combined with meteorological forecast data during transmission interruption.

For example, a photovoltaic power station is hit by strong wind and heavy rain, which caused the network signal to be interrupted for 2 hours. Inverter A (high-risk device): the previous fault prediction model marked abnormal heat dissipation, and the fault probability reached 85%. Inverter B (low-risk device): running normally, and the predicted fault probability is less than 5%. Data block 1: current and temperature data of inverter A. Data block 2: general state data of inverter B. Data is transmitted to data block 1 (completed) and data block 2 (interrupted when the transmission is 50%), and the data processing module records the breakpoint position. When the network signal is restored, data block 1 is transmitted first, and data block 2 is skipped.

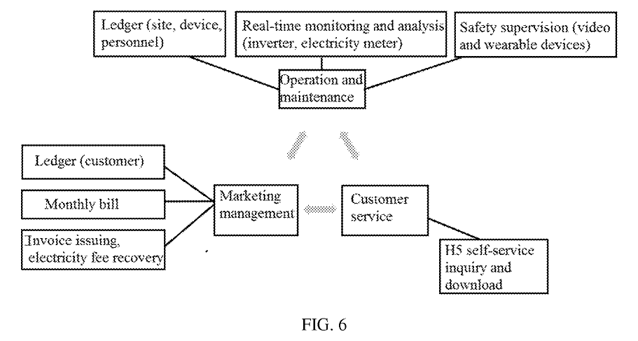

To sum up, as shown in FIG. 6, the distributed photovoltaic operation management system provided by the disclosure integrates smart meters, inverters, video monitoring and smart wearable devices through the device control module to realize real-time acquisition of multidimensional data and edge calculation pretreatment, and combines the data transmission module AES encryption and breakpoint continuous transmission technology to ensure the safety and reliability of data transmission. The data processing module builds an intelligent mapping model based on three-dimensional point cloud dynamic modeling, generative adversarial network (GAN) and attention mechanism, accurately predicts the risk of device fault in extreme weather and self-optimizes the algorithm. At the same time, the disclosure relies on blockchain evidence storage and automatic electricity bill settlement to realize the transparency and efficient recovery of photovoltaic bills. The control terminal provides user-friendly decision support and safe operation environment through visual interactive interface and closed-loop control instruction verification mechanism. The whole system integrates edge computing and artificial intelligence technology with modular layered architecture, which significantly reduces operation and maintenance costs, improves power generation efficiency, and enhances the power station's anti-risk ability. The disclosure provides a full-link solution for intelligent and digital operation of distributed photovoltaic, and integrates functions such as power collection, power settlement, invoicing and user service, which is convenient for users to use. At the same time, through the fusion of breakpoint continuous transmission and fusion prediction model, the dynamic classification of data priority and intelligent cutting of transmission content may be realized, which may identify key data blocks more accurately and avoid the efficiency bottleneck caused by "undifferentiated continuous transmission".

Those skilled in the art may realize that the units and algorithm steps of each example described in connection with the embodiments disclosed herein may be realized by electronic hardware, computer software or a combination of the electronic hardware and the computer software. In order to clearly illustrate the interchangeability of hardware and software, the assemblies and steps of each example have been generally described according to functions in the above description. Whether these functions are implemented in hardware or software depends on the specific application and design constraints of the technical scheme. Those skilled may use different methods to realize the described functions for each specific application, but this implementation should not be considered beyond the scope of the disclosure.

What is claimed is:

1. A distributed photovoltaic operation management system, comprising:
a device control module, comprising a smart meter deployed in a photovoltaic power station, a data collector on an inverter, a video monitoring device and a smart wearable device, wherein the device control module is configured for collecting data and environmental information of a photovoltaic power station device, and regulating and controlling the photovoltaic power station device;
a data transmission module, configured for providing an encrypted data transmission channel and supporting a breakpoint continuous transmission mechanism; and
a data processing module, configured for receiving data transmitted by the data transmission module and processing received data;
wherein the data collected by the device control module is encrypted and transmitted to the data processing module by the data transmission module.

2. The distributed photovoltaic operation management system according to claim 1, wherein the data processing module comprises:
a real-time monitoring submodule, configured for cleaning and detecting abnormality of electric energy data collected by the smart meter;
an electricity billing submodule, configured for generating bills and calculating photovoltaic subsidies according to the electric energy data and time-of-use electricity price rules; and
a security analysis submodule, configured for identifying security risks according to environmental information collected by the video monitoring device and the smart wearable device.

3. The distributed photovoltaic operation management system according to claim 2, wherein the electricity billing submodule comprises:
a blockchain evidence storage unit, configured for recording hash values of electricity transaction through Hyperledger Fabric;
an automatic invoicing unit, configured for docking a tax system and generating electronic invoices; and
a payment collection unit, configured for integrating a plurality of payment interfaces and supporting automatic debit and manual payment.

4. The distributed photovoltaic operation management system according to claim 1, wherein a preset intelligent mapping model is built in the data processing module, and the intelligent mapping model is configured for simulating device operation risks in extreme weather.

5. The distributed photovoltaic operation management system according to claim 4, wherein a construction method of the intelligent mapping model comprises:
obtaining three-dimensional point cloud data of the photovoltaic power station;
inputting type and position of each of devices in the photovoltaic power station into the three-dimensional point cloud data to generate a three-dimensional grid model with device attributes;
marking electrical connection topological relation in the three-dimensional grid model;
connecting meteorological data interfaces, obtaining future light intensity and temperature prediction.

6. The distributed photovoltaic operation management system according to claim 5, wherein an operation flow of the intelligent mapping model comprises:
obtaining data uploaded by the device control module and meteorological information in a future preset time period;
predicting device fault probability in the future preset time period through a preset fault prediction model according to obtained data and meteorological information;
according to predicted fault probability, highlighting risk devices in the three-dimensional grid model; and
optimizing parameters of an algorithm in the fault prediction model according to differences between actual maintenance records and prediction results of the fault prediction model;
wherein, the fault prediction model is constructed based on generating a countermeasure network and an attention mechanism.

7. The distributed photovoltaic operation management system according to claim 6, wherein predicting device fault probability in the future preset time period through a preset fault prediction model according to obtained data and meteorological information comprises:
simulating and generating device operation data by a generator according to historical data of the photovoltaic power station device;
analyzing obtained data and meteorological information through an attention mechanism, screening out features related to faults; and
predicting device fault probability in the future preset time period combined with the meteorological information in the future preset time period according to device operation data simulated by the generator and the features.

8. The distributed photovoltaic operation management system according to claim 6, wherein the data transmission module is configured for:
performing encryption processing all kinds of data transmitted by the device control module using an AES encryption algorithm in a process of data transmission; and
identifying breakpoint positions of data transmission and re-initiating data transmission requests when network is abnormal according to a preset data retransmission and recovery algorithm.

9. The distributed photovoltaic operation management system according to claim 1, wherein the distributed photovoltaic operation management system further comprises a control terminal configured with a display unit, wherein the control terminal is configured for receiving processing results of the data processing module and providing an interactive interface;
the control terminal sends control instructions according to user operations, and the control instructions are verified by the data processing module, and verified control instructions are transmitted to the device control module through the data transmission module, and the device control module performs specific operations according to received control instructions.

10. The distributed photovoltaic operation management system according to claim 6, wherein the breakpoint continuous transmission mechanism is configured for:
preferentially retransmitting data blocks associated with a high-risk device marked by the fault prediction model when a transmission is interrupted, and
skipping inverter data block transmission of having been predicted to be normal combined with meteorological forecast data during transmission interruption.
